(19) United States
(12) Patent Application Publication
(10) Pub. No.: US 2005/0122742 A1
(43) Pub. Date: Jun. 9, 2005

(54) Led lamp tube

(76) Inventor: Sung Tao Ho, Taipei (TW)

Correspondence Address: PRO-TECHTOR INTERNATIONAL, 20775 Norada Court, Saratoga, CA, 95070-3018, US

(21) Appl. No.: 10/729,181

(22) Filed: Dec. 4, 2003

(51) Int. Cl. F21V 7/04

(52) U.S. Cl. 362/615

(57) ABSTRACT

A LED lamp tube is constructed to include a light-guide shade and a light source mounted inside the light-guide shade, the light-guide shade having a light guide layer, two mounting portions extended from the light guide layer at two sides for mounting, and protruding portions arranged inside the light guide layer and defining a respective light guiding groove for producing a respective luminous arc when radiated with light, the light source being a circuit board holding a plurality of light emitting diodes that are controlled to emit light onto the light guiding grooves of the protruding portions to further produce luminous arcs.

### BACKGROUND OF THE INVENTION

1. Field of the Invention

The present invention relates to a LED lamp tube and, more particularly, to a power-saving, durable LED lamp tube, which comprises a specially designed tubular transparent light-guide shade and a LED module mounted inside the light-guide shade and controlled by a programmable controller to produce a lighting effect.

2. Description of the Related Art

Advertising signboards are commonly seen in streets, outside walls of buildings. These advertising signboards may be internally or externally mounted with lighting fixtures to produce a lighting effect that attracts people's eyes.

However, regular lighting fixtures such as neon lamps, incandescent lamps and bulbs, and recently developed high intensity discharge bulbs commonly consume much electric energy when turned on. Further, these lighting fixtures also product much heat energy during illumination, which heat energy may cause the materials of the signboards to change the quality. Lighting fixtures may fail due to excessively high temperature.

### SUMMARY OF THE INVENTION

The present invention has been accomplished to provide a LED lamp tube that eliminates the aforesaid drawbacks. It is therefore the main object of the present invention to provide a LED lamp tube, which is power-saving, easy to install, durable in use, and controllable by a programmable controller to produce different lighting patterns.

To achieve this and other objects of the present invention, the LED lamp tube comprises a light-guide shade, and a light source mounted inside the light-guide shade. The light-guide shade comprises a light guide layer, two mounting portions extended from two opposite sides of the light guide layer for mounting, and a plurality of protruding portions arranged inside the light guide layer and defining each a respective light guiding groove for producing a respective luminous arc when radiated with light. The light source comprises a circuit board mounted inside the light-guide shade, and a plurality of light emitting diodes mounted in the circuit board and adapted to emit light onto the light guiding grooves of the protruding portions to further produce luminous arcs.

### BRIEF DESCRIPTION OF THE DRAWINGS

FIG. 1-1 is an exploded view of a LED lamp tube according to the present invention.

FIG. 1-2 is an enlarged view of part A of FIG. 1-1.

FIG. 2 is a schematic side view of the LED lamp tube according to the present invention.

FIG. 3 is a schematic drawing showing the lamination of the LEDs in the light-guide shade according to the present invention.

FIG. 4 is a schematic drawing showing luminous arcs produced at the light-guide shade according to the present invention.

FIG. 5-1 is similar to FIG. 2 but showing the light source adjusted to a relatively higher position.

FIG. 5-2 is similar to FIG. 5-1 but showing the light source adjusted to a top position.

FIG. 6 illustrates a semitransparent photo mask coated on the outside wall of the light-guide shade according to the present invention.

FIG. 7 is a schematic drawing showing the LED lamp tube used with a reflector according to the present invention.

FIG. 8 is a schematic drawing showing a number of LED lamp tubes mounted with reflectors in a lamp box according to the present invention.

### DETAILED DESCRIPTION OF THE PREFERRED EMBODIMENT

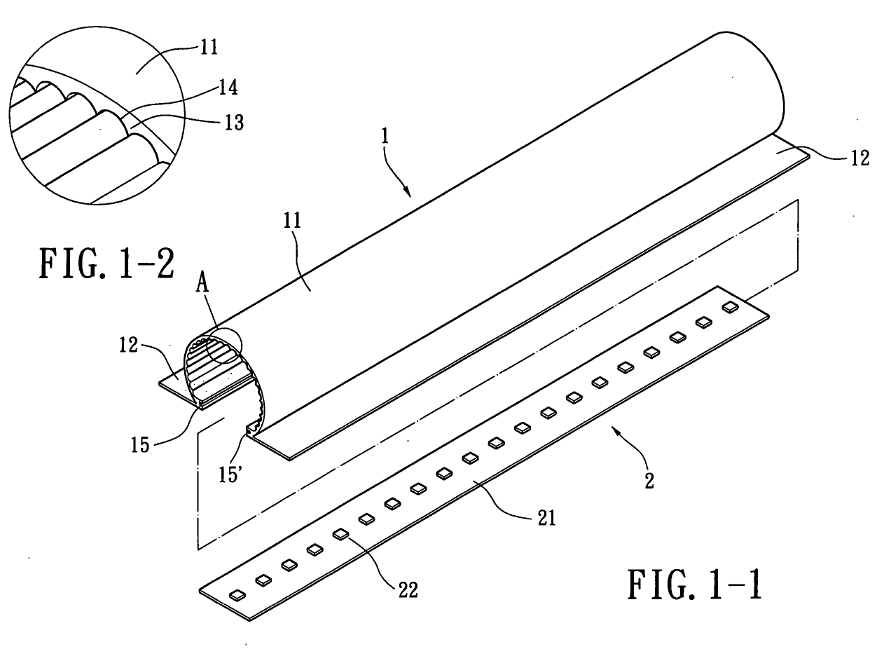

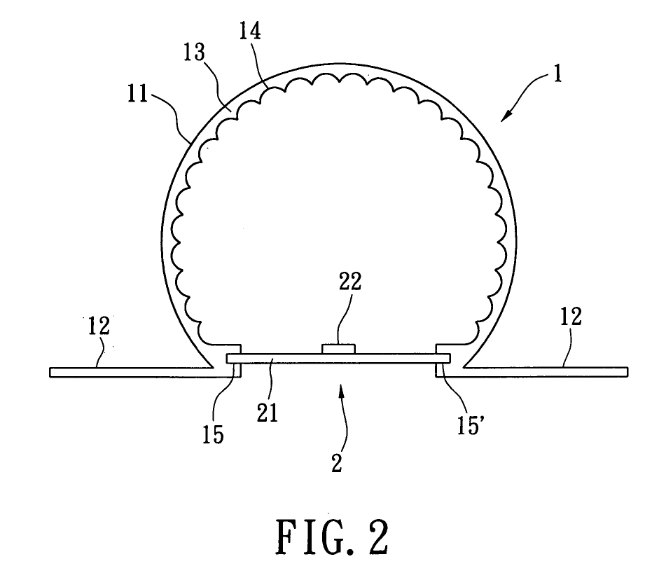

Referring to FIGS. 1-1 and 1-2, a LED lamp tube is shown comprised of a light-guide shade 1, and a light source 2 mounted inside the light-guide shade 1.

The 1 light-guide shade 1 can be molded from transparent or opaque plastics, having a light guide layer 11, two mounting portions 12 extended from two opposite sides of the light guide layer 11 for enabling the light-guide shade 1 to be fastened to a lamp box (not shown) or floor panel, protruding portions 13 arranged on the inside wall of the light guide layer 11 (the protruding portions 13 can be made to form a serrated, arched, corrugated, or spiral structure on the inside the light guide layer 11) and defining each a respective light guiding groove 14 for producing luminous arcs, and at least one, for example, two linear coupling grooves 15 and 15′ bilaterally provided on the inside wall of the light-guide shade 1 for receiving the light source 2.

The light source 2 comprises a circuit board 21, and a plurality of LEDs (light emitting diodes) 22 mounted in the circuit board 21 and controlled by a control circuit (not shown) at the circuit board 21 to produce a lighting effect. The LEDs 22 may have one single color, or different colors.

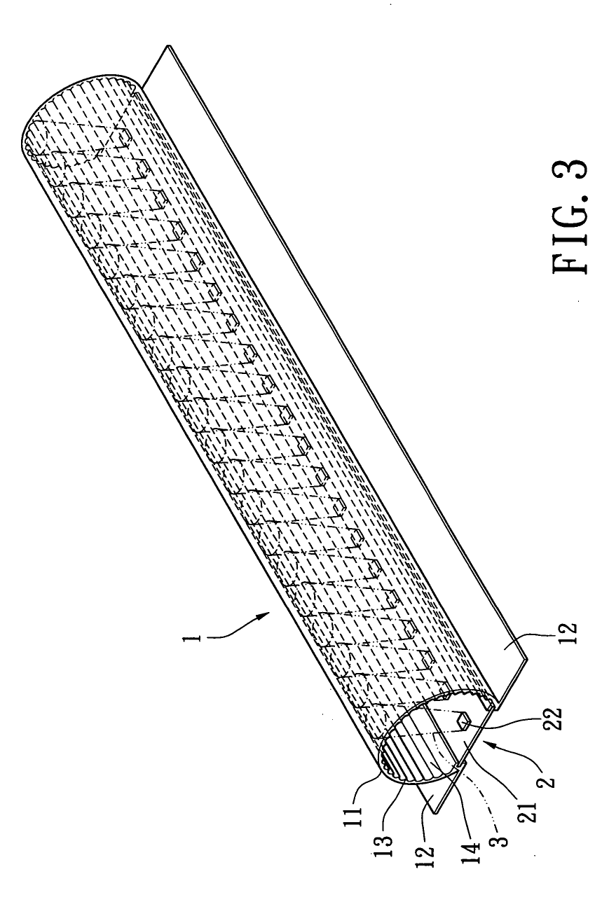

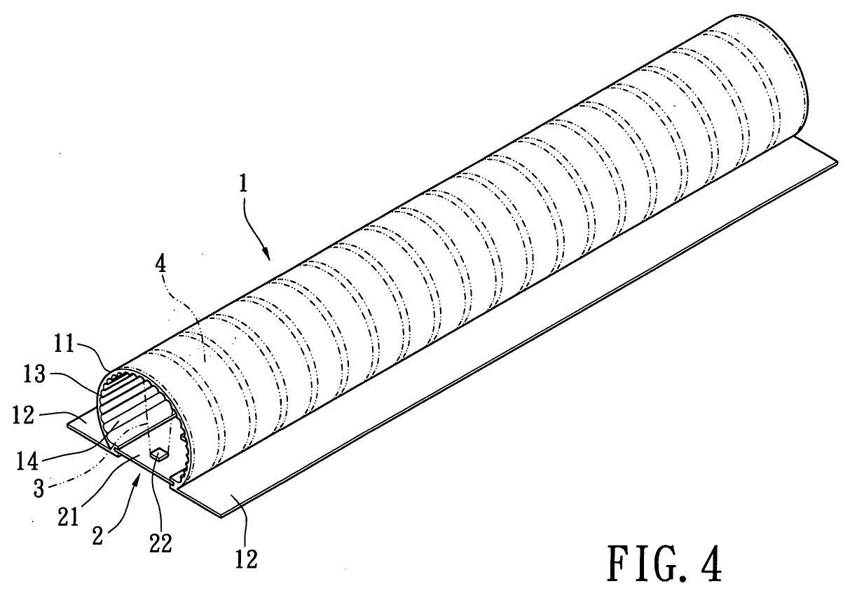

Referring to FIGS. 2-4, the circuit board 21 of the light source 2 is mounted in the coupling grooves 15 and 15′, and then connected to power source. When electrically connected, the control circuit of the circuit board 21 controls the LEDs 22 to emit light 3 onto the light guiding grooves 14 at the protruding portions 13, thereby causing luminous arcs 4 to be produced at the light-guide shade 1 for illumination as well as for causing a sense of beauty.

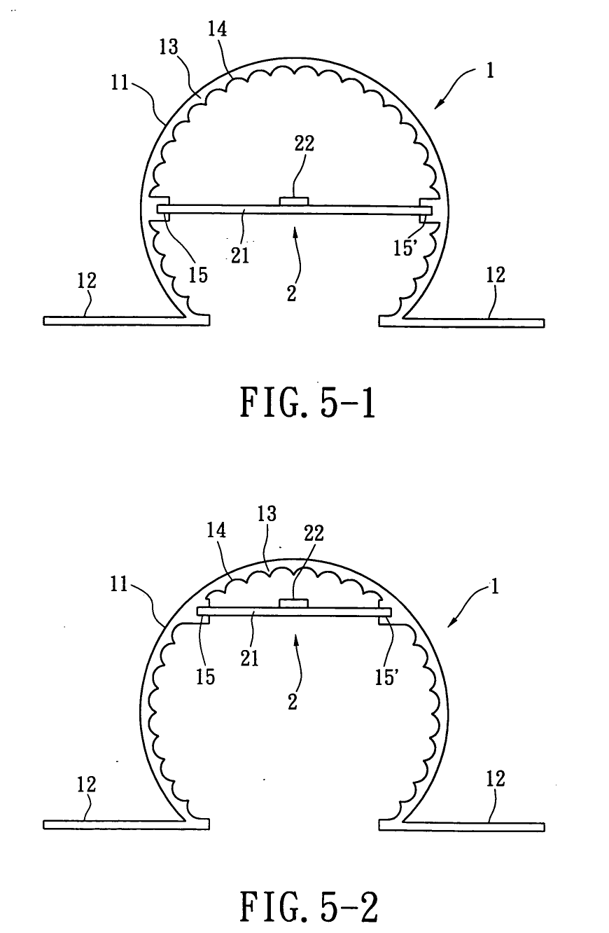

Referring to FIGS. 5-1 and 5-2, pairs of coupling grooves 15 and 15′ may be provided inside the light-guide shade 1 at different elevations for selectively receiving the light source 2. Therefore, the light source 2 can be mounted inside the light-guide shade 1 in one of a series of positions selectively.

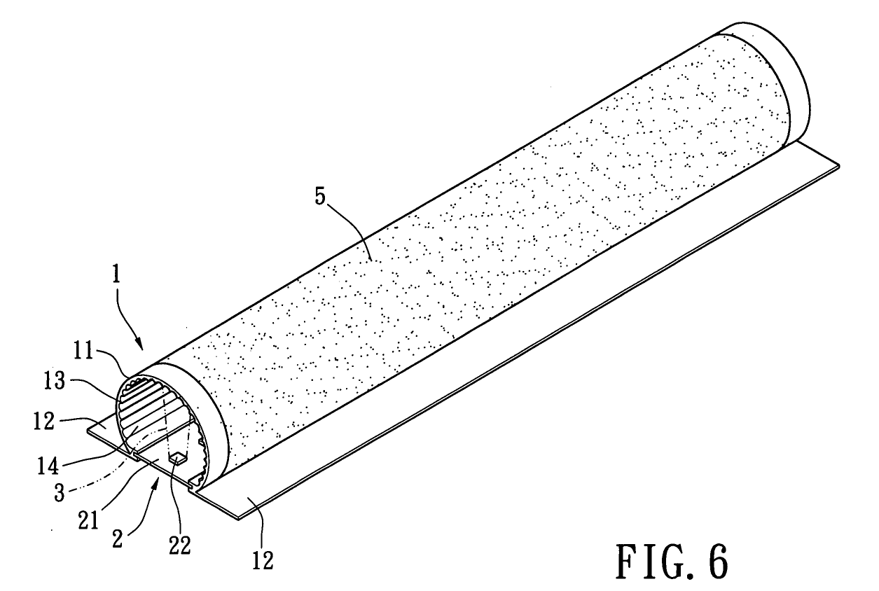

Referring to FIG. 6, a colored, or colorless, or frosted semitransparent photo mask 5 may be coated on the outside wall of the light-guide shade 1 to soften light from the LEDs 22.

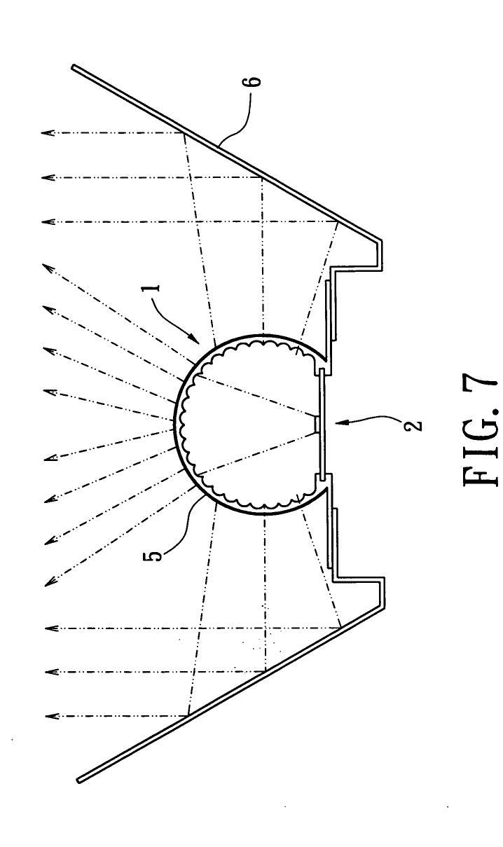

Referring to FIG. 7, a reflector 6 may be provided outside the light-guide shade 1 to reflect light passing through the light-guide shade 1 toward a specific direction.

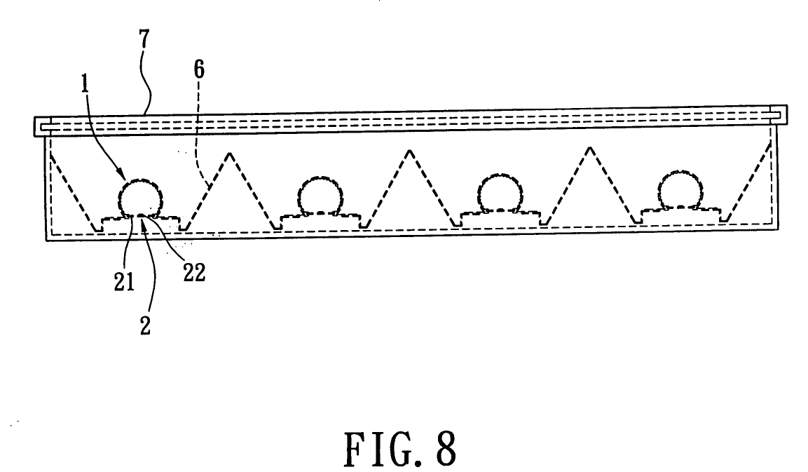

FIG. 8 shows an application example of the present invention. According to this application example, multiple LED lamp tubes are mounted with reflectors 6 inside a lamp box 7.

Further, the circuit board 21 of the light source 2 can be connected to an external control device, for example, DMX controller or personal computer that controls the lighting pattern of the LEDs 22. Electric connectors may be used to electrically connect the circuit board 21 of the light source 2 to external devices or circuit boards for easy installation and maintenance.

Although particular embodiments of the invention have been described in detail for purposes of illustration, various modifications and enhancements may be made without departing from the spirit and scope of the invention. Accordingly, the invention is not to be limited except as by the appended claims.

1. A LED lamp tube comprising:
a light-guide shade, said light-guide shade comprising a light guide layer, two mounting portions extended from two opposite sides of said light guide layer for mounting, and a plurality of protruding portions arranged inside said light guide layer, said protruding portions each defining a light guiding groove for producing a luminous arc when radiated with light; and
a light source, said light source comprising a circuit board mounted inside said light-guide shade, and a plurality of light emitting diodes mounted in said circuit board and adapted to emit light onto the light guiding grooves of said protruding portions to further produce luminous arcs.

2. The LED lamp tube as claimed in claim 1, wherein said light guide shade is molded from one of transparent and opaque plastic materials.

3. The LED lamp tube as claimed in claim 1, wherein said protruding portions are arranged to form one of serrated, arched, and corrugated structures.

4. The LED lamp tube as claimed in claim 1, wherein said protruding portions are spirally arranged inside said light guide layer.

5. The LED lamp tube as claimed in claim 1, wherein said light-guide shade has at least one linear coupling groove.

6. The LED lamp tube as claimed in claim 1, wherein said circuit board comprises a control circuit.

7. The LED lamp tube as claimed in claim 1, wherein said light emitting diodes have different colors.

8. The LED lamp tube as claimed in claim 1, wherein said light-guide shade has an outside wall coated with a layer of photo mask selected from colored, colorless, and frosted semitransparent photo masks.

9. The LED lamp tube as claimed in claim 1, wherein said light-guide shade is mounted with a reflector.

10. The LED lamp tube as claimed in claim 9 further comprising a reflector fastened with said light-guide shade in a lamp box.

11. The LED lamp tube as claimed in claim 1, wherein said circuit board of said light source is connected to an external controller (DMX controller or personal computer) that controls the lighting pattern of said light emitting diodes.

12. The LED lamp tube as claimed in claim 1, wherein said circuit board of said light source has electric connector means for connection to external circuit means.
